(19) United States
(12) Patent Application Publication
(10) Pub. No.: US 2022/0405283 A1
(43) Pub. Date: Dec. 22, 2022

(54) REFLECTION CREATION SYSTEM, REFLECTION CREATION METHOD, AND REFLECTION CREATION PROGRAM

(71) Applicant: Hitachi, Ltd., Tokyo (JP)

(72) Inventors: Yuichiro AOKI, Tokyo (JP); Satoru WATANABE, Tokyo (JP)

(21) Appl. No.: 17/698,434

(22) Filed: Mar. 18, 2022

(30) Foreign Application Priority Data
Jun. 18, 2021 (JP) 2021-101984

(51) Int. Cl. G06F 16/2453; G06F 16/242

(52) U.S. Cl. CPC G06F 16/24539; G06F 16/2425; G06F 16/2433

(57) ABSTRACT

A reflection creation system 1 includes a storage device 3 that holds a history 24 of reflections and an arithmetic device 2 that selects, from the history, a query whose reflection creation source is different from that of a new query for reflection creation among queries related to a past reflection having a same content as that of a reflection represented by the new query, based on the content of the reflection, and creates a reflection based on the selected query of the past reflection.

### CROSS-REFERENCE TO RELATED APPLICATION

This application claims priority pursuant to Japanese patent application No. 2021-101984, filed on Jun. 18, 2021, the entire disclosure of which is incorporated herein by reference.

### BACKGROUND

### Technical Field

The present invention relates to a reflection creation system, a reflection creation method, and a reflection creation program.

### Related Art

With the current spread of COVID-19, COVID-19-related data of various file formats are being transmitted every day from the government, local governments, hospitals, health centers, and the like. For the purposes of using these data, it is not permissible to spend a long time analyzing the data. Therefore, high-speed data analysis is required.

At stores and factories that handle daily data of POS (Point Of Sales) and IoT (Internet Of Things), it is necessary to complete the analysis of such daily data by the following day. In other words, high-speed data analysis is also required in such business fields and industries.

Therefore, there are thought to be many cases in the world where data with similar structures are generated one after another and such large amounts of data are to be analyzed within a certain period of time. In the fields that require such high-speed data analysis, the use of reflection that speeds up data access is advancing.

This reflection is a function of the SQL (Structured Query Language) engine Dremio (https://www.dremio.com) for open source data lakes. The reflection speeds up the query by having a partial copy of data (extracted columns, calculation results of aggregate operations, and the like).

In essence, the reflection is the same function as a materialized view (also called a materialized view table) of a relational database management system (RDBMS). However, this materialized view is a function that is applicable only to a relational database (RDB).

On the other hand, the reflection is more useful because the reflection can provide the same function as the materialized view to data (semi-structured data such as a CSV format file and a JSON format file) other than the RDB in a data lake.

As a conventional technique related to the reflection described above, there has been proposed a method of providing a technique capable of efficiently using a materialized view table when performing database processing with a plurality of queries, for example (see Patent Document 1) and the like.

This technique includes, in a materialized view table creation method for creating a materialized view table, the steps of: detecting a derived table commonly used in a plurality of queries and storing the detected table in a storage device as a derived table list; creating definition information for creating a derived table in the derived table list as a materialized view table, storing the definition information in the storage device, and instructing creation of a materialized view table based on the definition information; and converting a description in the query into a description using the created materialized view table and storing the description in the storage device.

### PRIOR ART DOCUMENT

### Patent Document

[Patent Document 1] Japanese Patent Application Publication No. 2006-343798

### Non-Patent Document

[Non-Patent Document 1] https://docs.dremio.com/acceleration/creating-reflections.h tml

### SUMMARY

However, in the conventional technique, it is necessary to manually create a reflection for an SQL query (query using SQL for a data set). The technique disclosed in Non-Patent Document 1 shows a method for manually creating reflections. When this technique is adopted, it is necessary to create at least one SQL query for reflection creation for one SQL query.

Such manual reflection creation for each SQL query requires a large amount of man-hours, which itself hinders high-speed data analysis.

According to the technique disclosed in Patent Document 1, a materialized view table can be created by detecting a derived table commonly used in a plurality of queries.

However, this technique is used to create a new materialized view table using history information when the same derived table used in the past is used, and is not applicable to similar but not the same derived tables and SQL queries. The technique is also not applicable to the case where the query is a non-SQL query (tag query, natural language query, and the like). Further, the technique is also limited to RDB.

Therefore, it is an object of the present invention to provide a technique that enables automatic reflection creation for SQL queries by using a reflection creation history.

A reflection creation system of the present invention that solves the above problems includes a storage device that holds a history of reflections; and an arithmetic device that selects, from the history, a query whose reflection creation source is different from that of a new query for reflection creation among queries related to a past reflection having the same content as that of a reflection represented by the new query, based on the content of the reflection, and creates a reflection based on the selected query of the past reflection.

In a reflection creation method of the present invention, an information processing apparatus including a storage device that holds a history of reflections executes processing of: selecting, from the history, a query whose reflection creation source is different from that of a new query for reflection creation among queries related to a past reflection having the same content as that of a reflection represented by the new query, based on the content of the reflection; and creating a reflection based on the selected query of the past reflection.

A reflection creation program of the present invention causes an information processing apparatus including a storage device that holds a history of reflections to execute processing of selecting, from the history, a query whose reflection creation source is different from that of a new query for reflection creation among queries related to a past reflection having the same content as that of a reflection represented by the new query, based on the content of the reflection, and creating a reflection based on the selected query of the past reflection.

According to the present invention, reflections can be automatically created for SQL queries by using a reflection creation history.

### BRIEF DESCRIPTION OF THE DRAWINGS

FIG. 1 is a diagram showing a configuration example of a reflection creation system according to an embodiment of the present disclosure.

FIG. 2 is a diagram showing the overall processing of a reflection creation method according to the embodiment of the present disclosure.

FIG. 3 is a diagram showing a flow example of a reflection creation part according to the embodiment of the present disclosure.

FIG. 4 is a diagram showing a flow example of a query semantic analysis part according to the embodiment of the present disclosure.

FIG. 5 is a diagram showing a flow example of a reflection determination part according to the embodiment of the present disclosure.

FIG. 6 is a diagram showing a configuration example of a reflection history table according to the embodiment of the present disclosure.

FIG. 7 is a diagram showing a flow example of the reflection creation part according to the embodiment of the present disclosure.

FIG. 8 is a diagram showing a flow example of the query semantic analysis part according to the embodiment of the present disclosure.

FIG. 9 is a diagram showing a flow example of the reflection creation part according to the embodiment of the present disclosure.

FIG. 10 is a diagram showing a configuration example of a reflection history table according to the embodiment of the present disclosure.

FIG. 11 is a diagram showing an example of a log file according to the embodiment of the present disclosure.

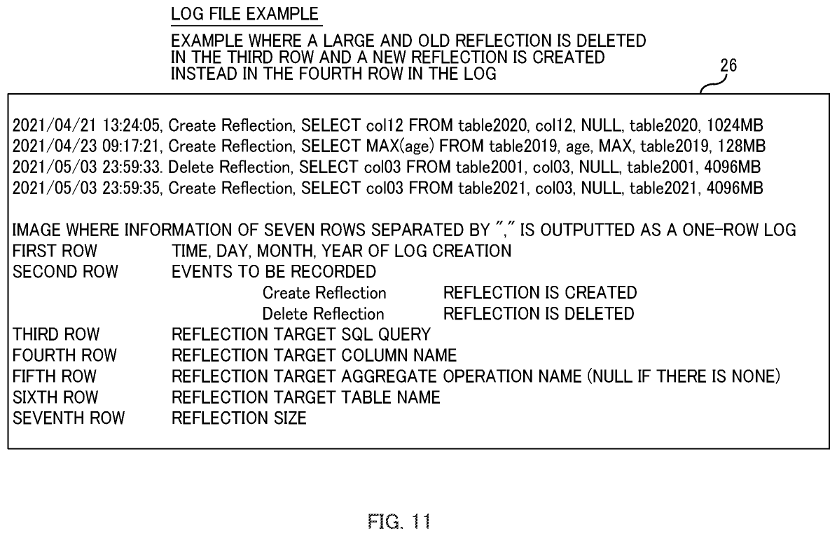

### DETAILED DESCRIPTION OF EMBODIMENTS

### Configuration of Reflection Creation System

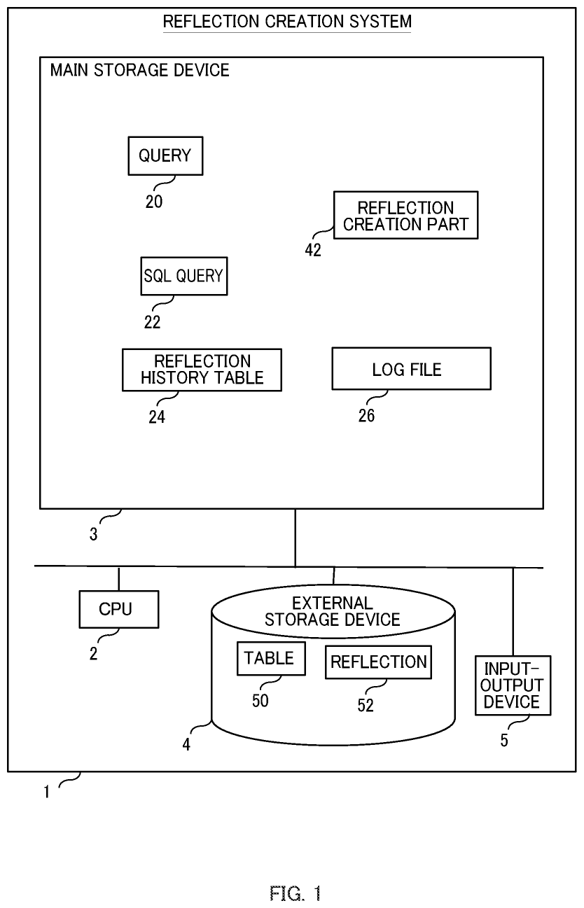

With reference to the drawings, embodiments of the present invention will be described in detail below. FIG. 1 is a diagram showing a configuration example of a reflection creation system 1 according to an embodiment of the present disclosure. The reflection creation system 1 shown in FIG. 1 is a computer system that can automatically create reflections for SQL queries by using a reflection creation history.

While description will be given by using the term “reflection” in the embodiment of the present disclosure, the reflection is essentially the same as the materialized view in the RDBMS as described above, and thus the present invention is also applicable to the materialized view in the RDBMS.

As shown in FIG. 1, the reflection creation system 1 according to the embodiment of the present disclosure includes a central processing unit (CPU) 2, a main storage device 3, an external storage device 4, and an input-output device 5.

The CPU 2 is an arithmetic device that reads and executes programs held in the main storage device 3 and the external storage device 4, and performs integrated control as well as various determination, calculation, and control processing.

The main storage device 3 includes a volatile storage element such as a random access memory (RAM). The main storage device 3 includes a query 20, an SQL query 22, a reflection history table 24, a log file 26, and a reflection creation part 42.

The query 20 is not an SQL statement, but a colloquially described query, for example, which is a query for creating a reflection. This query 20 is received and acquired from a user via the input-output device 5.

The SQL query 22 is a query described in the form of an SQL statement, and is a query for creating a reflection. The SQL query 22 may also include one obtained by converting the query 20 described above by a query-to-SQL query conversion part 42A1A to be described later.

The reflection history table 24 is a table that stores a history generated by extracting reflections from a data lake to be the target of reflection creation.

The log file 26 is a file to be outputted to an appropriate person such as a system administrator, in which the content of reflection creation, an update process, and the like are described.

The reflection creation part 42 is also a function to execute a reflection creation method according to the embodiment of the present disclosure.

The external storage device 4 includes an appropriate non-volatile storage element such as a solid state drive (SSD) or a hard disk drive. The external storage device 4 stores a table 50 and a reflection 52.

The table 50 is a table in the data lake, which is the target of column extraction by the reflection creation part 42.

The reflection 52 is created by the reflection creation part 42 described above.

The input-output device 5 is assumed to be an input device that receives key input and voice input from the user, and an output device such as a display that displays processed data.

### Flow Example

With reference to the drawings, description will be given below of an actual procedure of the reflection creation method according to the embodiment of the present disclosure. Various operations corresponding to the reflection creation method described below are realized by a program read into the main storage device 3 and executed by the reflection creation system 1. The program includes codes for performing the various operations described below.

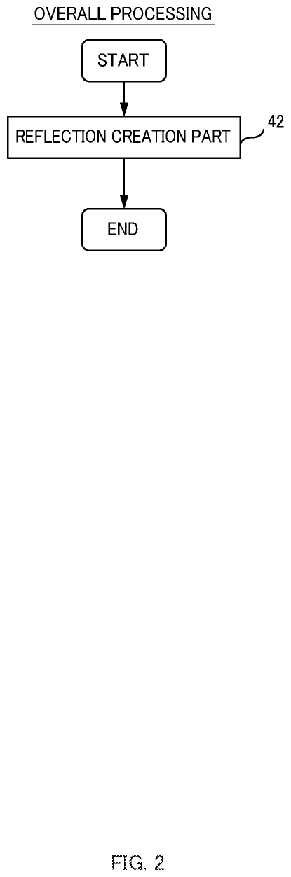

FIG. 2 is a diagram showing an example of the main flow of the reflection creation method according to the embodiment of the present disclosure. In this case, the reflection creation part 42 in the reflection creation system 1 creates a reflection by analyzing a query (either the query 20 or the SQL query 22) inputted via the input-output device 5. This processing will be described in detail later.

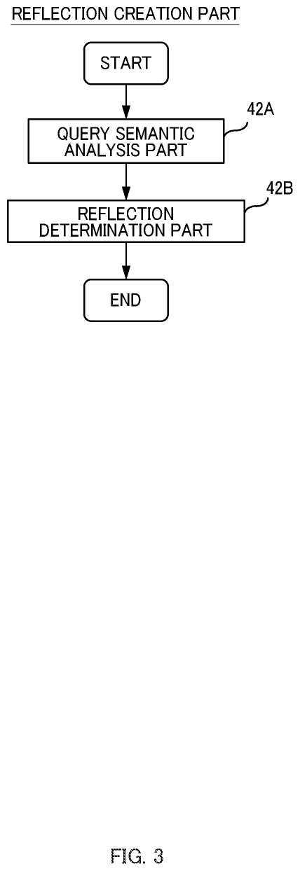

Next, FIG. 3 shows a processing flow in the reflection creation part 42 according to the embodiment of the present disclosure. In this flow, a query semantic analysis part 42A executes processing, and then a reflection determination part 42B executes processing.

The query semantic analysis part 42A analyzes the meaning of the query 20 and converts the query 20 into the SQL query 22. The reflection determination part 42B uses the SQL query 22 generated by the query semantic analysis part 42A described above and the reflection history table 24 to create a reflection, and updates the reflection history table 24.

Here, the processing in the above-described query semantic analysis part 42A will be described in detail. The query semantic analysis part 42A causes the query-to-SQL query conversion part 42A1A to execute processing.

In this case, the query-to-SQL query conversion part 42A1A converts the above-described query 20 into an SQL query 22. As described above, the query 20 is a general query other than the SQL query, and refers to an inquiry (query) made to a data set by various ways of expression.

For example, a tag query using a “tag” attached to the data set itself or to a column of the data set can be assumed. As an example of the tag, a case is assumed where, given a data set as shown in Table 1 below (assuming that the data set has a name c2020), a tag name “last name” is assigned to “Name 1” column, a tag name “first name” is assigned to “Name 2” column, and a tag name “customer data 2020” is assigned to the data set.

TABLE 1

| Customer Number | Name 1 | Name 2 |
|---|---|---|
| 1 | Yamada | Taro |
| 2 | Ueno | Hanako |

In other words, the tag is a name (tag name) that represents the “meaning” of the data set or column.

In the SQL query, it is necessary to describe a query such as SELECT Name 1 and Name 2 FROM c2020 that can only be recognized by experts who are familiar with that data set . In the tag query, on the other hand, it is possible to describe a query in a form that can be easily recognized by anyone, such as SELECT last name and first name FROM customer data 2020.

Generally, a tag query management system holds a correspondence table of names of data sets, columns, and the like corresponding to tag names. Therefore, when converting from a tag query to an SQL query, the query-to-SQL query conversion part 42A1A replaces the tag name with the data set name or column name using the correspondence table.

As the query 20 described above, a natural language query using a natural language such as written words and voices can also be assumed. For example, in the case of written words, a query such as “extract the customer's last name and first name from the customer data of 2020” is applicable.

When converting from such a natural language query to an SQL query, the query-to-SQL query conversion part 42A1A performs SQL conversion by creating a classifier to determine what in an SQL syntax each word in the natural language query corresponds to, with the logic corresponding to a known method using, for example, machine learning (for example, Victor Zhong, Caiming Xiong, and Richard Socher, “Seq2SQL: Generating Structured Queries FROM Natural Language using Reinforcement Learning,” arXiv: 1709.00103, 2017, https://arxiv.org/pdf/1709.00103.pdf).

Also, in the case of a voice natural language query, it can be assumed that an inquiry “Extract the customer's last name and first name from the customer data of 2020” is made via voice.

In this case, it can be assumed that the query-to-SQL query conversion part 42A1A uses Speech to Text technology (for example, https://eprints.lib.hokudai.ac.jp/dspace/bitstream/2115/396 53/1/MP-SS1-3.pdf), which is a technology for converting a speech into a text, to convert a natural language query using a voice into a natural language query using written words and further into an SQL query.

In addition, it is also conceivable that moving images such as sign language and gestures (body language) are given to an image analysis engine, converted to the meaning of body movement and posture, and then further converted to an SQL query based on the combination of the meanings. It is a matter of course that, in that case, a correspondence table or a machine learning model related to the syntax and description of the SQL query is prepared in advance with respect to the meanings of the movements or postures of the body and the combination of the meanings, and the query-to-SQL query conversion part 42A1A can use such a table or model.

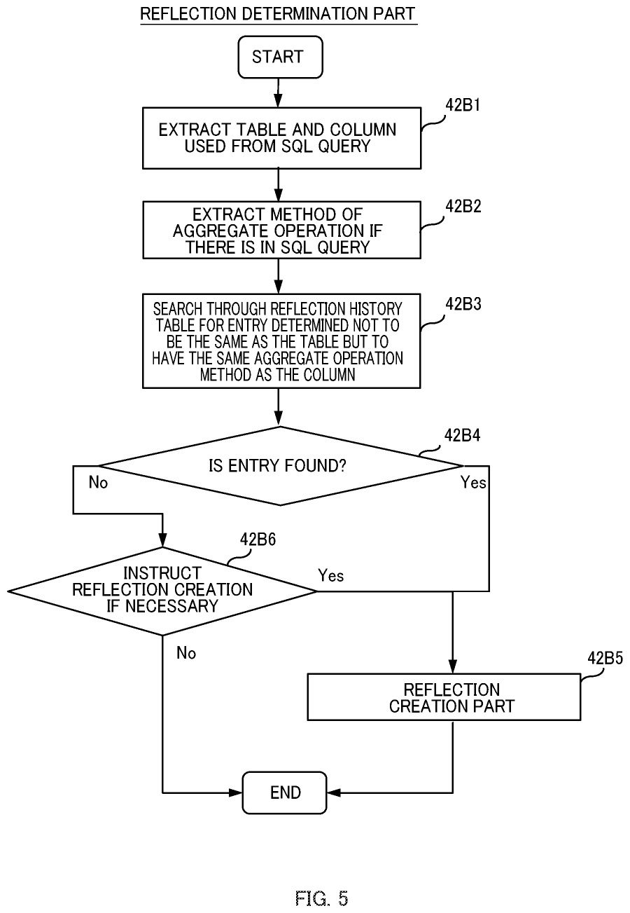

Subsequently, the flow of the reflection determination part 42B described above will be described with reference to FIG. 5. The reflection determination part 42B receives the SQL query 22 and causes the reflection creation part 42 to execute reflection creation by using the reflection history table 24.

As an example of the SQL query 22 described here, SELECT SUM (col12) FROM table2020 or the like is adopted, for example.

First, the reflection determination part 42B extracts a column and a table to be used for reflection creation from the received SQL query 22 in step 42B1. In the case of the example of the SQL query 22 described above, this step corresponds to extracting “col12” as a column and “table2020” as a table.

Then, in step 42B2, when the SQL query 22 described above includes a description of an aggregate operation, the reflection determination part 42B extracts the description of the aggregate operation. In the case of the example of the SQL query 22 described above, this step corresponds to extracting the aggregate operation “SUM” for “col12”. On the other hand, when the SQL query 22 does not include any description of the aggregate operation (in the case of, for example, SELECT col12 FROM table2020), the execution of this step is omitted.

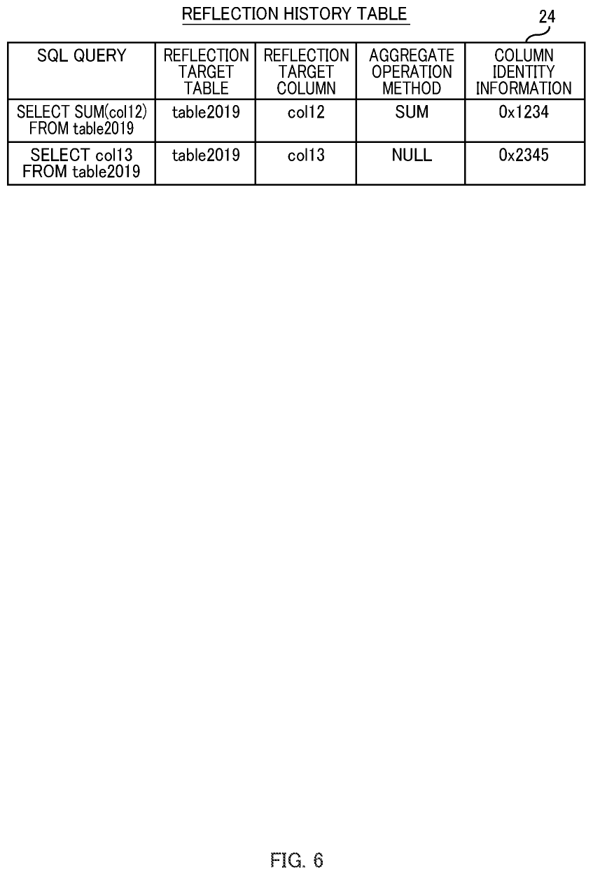

Subsequently, in step 42B3, the reflection determination part 42B searches through the reflection history table 24 (see FIG. 6, details will be described later) for an entry (row) which has the same reflection target column as the column extracted in step 42B1 and the same aggregate operation method as the aggregate operation extracted in step 42B2, and has a reflection target table different from the table extracted in step 42B1.

Here, a situation where the columns are the “same” assumes a situation that represents the following cases, but is not limited thereto. “Same” means, for example, when at least one of the column name and the tag name assigned to the column is the same, it is determined that the columns are the “same”.

Alternatively, the columns whose statistical information (number, average value, maximum value, and the like) and metadata on the data contained in the columns are within a predetermined range are determined to be the same. The metadata here is additional data about certain data itself that accompanies that data, and assumes data generation time, data access authority, data size, and the like.

When data determined and generated with predetermined logic (found in, for example, https://www.hitachivantara.com/en-us/pdf/white-paper/using-ai-ml-to-power-data-fingerprinting-whitepaper.pdf) have the same characteristic information, the columns maybe determined to be the “same”.

Further, columns that are determined to be the same by a data catalog technology (found in, for example, https://www.oracle.com/big-data/what-is-a-data-catalog/) may also be treated as the “same”.

On the other hand, a situation where the tables are “different” refers to the following cases, but is not limited thereto. “Different” means that when the table names or the tag names assigned to the tables are different, it is determined that the tables are “different”.

Alternatively, the tables whose statistical information (number, average value, maximum value, and the like) and metadata on the data contained in the table do not fall within a predetermined range are determined to be different from each other.

When data determined and generated with predetermined logic (found in, for example, https://www.hitachivantara.com/en-us/pdf/white-paper/using-ai-ml-to-power-data-fingerprinting-whitepaper.pdf) have different characteristic information, the tables may be determined to be the “different”.

Further, tables that are determined to be different by a data catalog technology (found in, for example, https://www.oracle.com/big-data/what-is-a-data-catalog/) may also be treated as “different”.

Here, referring back to the description of the flow, when an entry is found in the reflection history table 24 as a result of the processing in step 42B3 in the determination of step 42B4 (42B4: Yes), the reflection determination part 42B executes reflection creation (step 42B5).

On the other hand, when no entry is found in the reflection history table 24 as a result of the determination described above (42B4: No), the reflection determination part 42B instructs, if necessary, reflection creation for the SQL query 22 via a user interface of the input-output device 5 (step 42B6) and then terminates this flow.

When the reflection history table 24 is empty and a history of a first reflection is to be created or when a reflection is to be created for a completely different SQL query (which is not listed in the reflection history table, of course).

When the target SQL query 22 is complicated (example: SELECT name1 FROM table1 UNION SELECT name2 FROM table2) and one SQL query 22 has a plurality of SELECT statements, or the like, the flow of FIG. 5 is repeated for each SELECT statement or the like.

Here, FIG. 6 shows an example of the reflection history table 24 according to the embodiment of the present disclosure. In this reflection history table 24, the columns are arranged from left in the order of an SQL query column, a reflection target table column, a reflection target column, an aggregate operation method column, and a column identity information column. Each entry (row) in the reflection history table 24 according to the embodiment of the present disclosure stores information on the SQL query for which the reflection has been created before.

In the reflection target table column, the name of the table used to create the reflection for the SQL query 22 is recorded. In the reflection target column, the name of the column used to create the reflection for the SQL query 22 is recorded.

In the aggregate operation method column, the aggregate operation described in the SQL query 22 is recorded. However, when no aggregate operation is described, “NULL” is recorded in the column.

In the column identity information column, statistical information on data included in the column, characteristic information on data determined and generated with predetermined logic, information on metadata given to the column, determination information on data catalog technology, and the like are recorded. This column identity information column may record not only a single piece of information but also a link (such as a pointer) to another table that describes one or more of the above information.

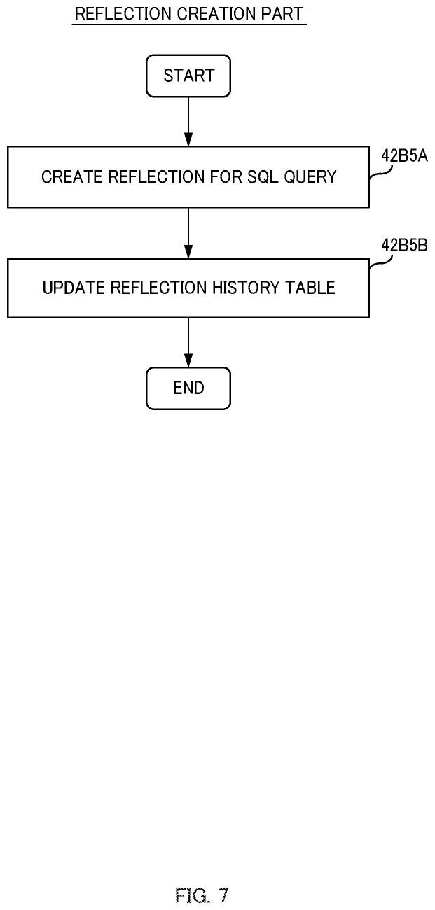

Subsequently, update processing of the reflection history table 24 in the reflection creation part 42 will be described with reference to FIG. 7. First, in step 42B5A, the reflection creation part 42 generates a reflection for the SQL query 22.

In this case, when a data set is not in tabular format (RDB table) such as a CSV file, a JSON file, and a spreadsheet file, the reflection creation part 42 uses software such as Dremio that is an open-source SQL engine for data lake (for example, https://docs.dremio.com/data-sources/file-upload.html) to convert such a file format into a tabular format.

When the data set is an XML file, the reflection creation part 42 may perform conversion by reading the file with a known data management system or the like (for example, https://docs.oracle.com/cd/E11882_01/appdev.112/e23094/xdb2 6imp.htm#ADXDB5733).

As for the reflection creation method, when the SQL query 22 is, for example, SELECT col13 FROM table2019, Dremio generates and executes an SQL query for reflection creation called ALTER DATASET table2019 CREATE RAW REFLECTION ref1 USING DISPLAY (col13) (for example, https://docs.dremio.com/SQL-reference/SQL-commands/accelera tion.html).

In the case of the RDBMS materialized view, PostgreSQL, for example, generates and executes an SQL query for reflection creation called CREATE MATERIALIZED VIEW ref1 AS SELECT col13 FROM table2019 (for example, https://www.postgreSQL.org/docs/9.3/SQL-CREATEmaterializedv iew.html).

In step 42B5B, the reflection creation part 42 updates the reflection history table 24 and then terminates the flow. In this update processing, one row is added to the entries (rows) in the reflection history table 24, and the SQL query 22, the reflection target table and reflection target column of the SQL query 22 extracted instep 42B1, the aggregate operation method extracted in step 42B2, and the column identity information used for identity determination of the reflection target table and the reflection target column are written in the added row.

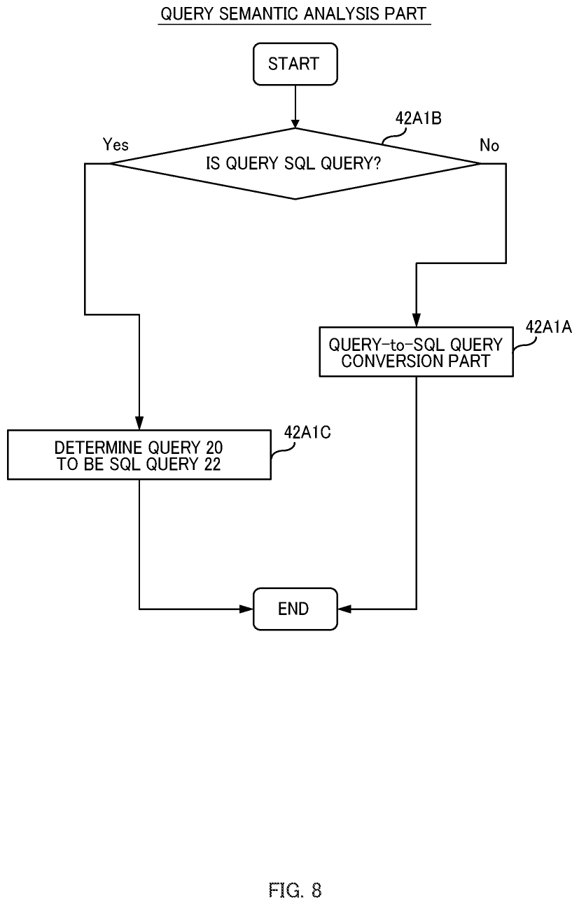

Next, the processing in the query semantic analysis part 42A will be described with reference to FIG. 8. In this case, the query semantic analysis part 42A determines in step 42A1B whether or not the query 20 is an SQL query according to the SQL standard.

As a result of the determination, when the query 20 is an SQL query (42A1B: Yes), the query semantic analysis part 42A copies the query 20 to the SQL query 22 in step 42A1C and then terminates the processing.

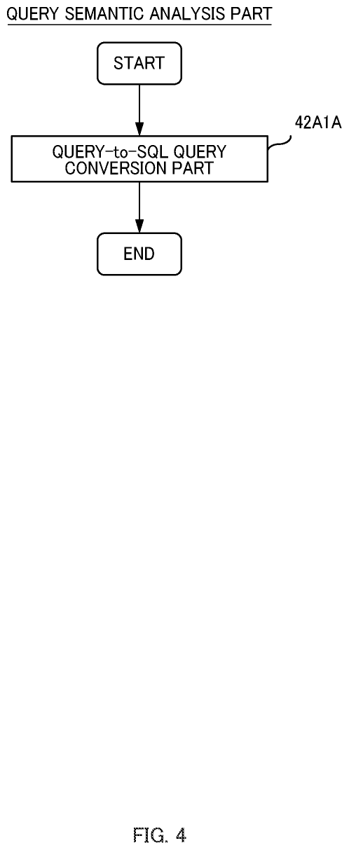

On the other hand, when the query 20 is not an SQL query (42A1B: No) as a result of the determination described above, the query semantic analysis part 42A executes the query-to-SQL query conversion step 42A1B. This query-to-SQL query conversion step has already been described with reference to FIG. 4.

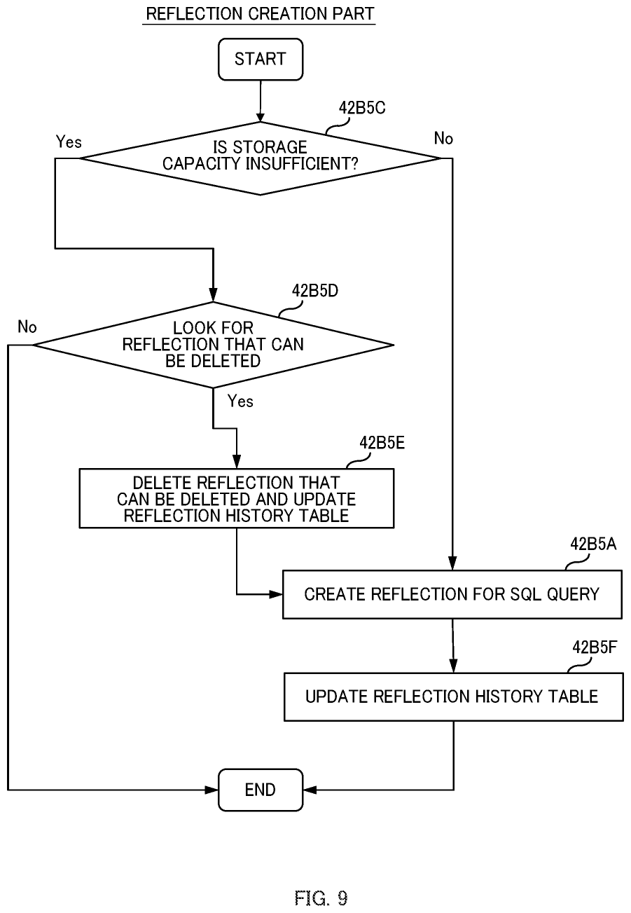

Subsequently, the processing of the reflection creation part 42 will be described with reference to FIG. 9. In this case, the reflection creation part 42 determines in step 42B5C whether the storage capacity required to store reflections to be created does not exceed the maximum reflection storage capacity.

The determination method in this case is checking if the inequality of maximum reflection storage capacity> existing reflection storage capacity + storage capacity required to store the current reflection is satisfied.

The maximum reflection storage capacity is the maximum storage capacity of a primary storage (memory) and a secondary storage (storage) that can be used by the user. As for this maximum reflection storage capacity, it is assumed that the value is set in a setting file or the like.

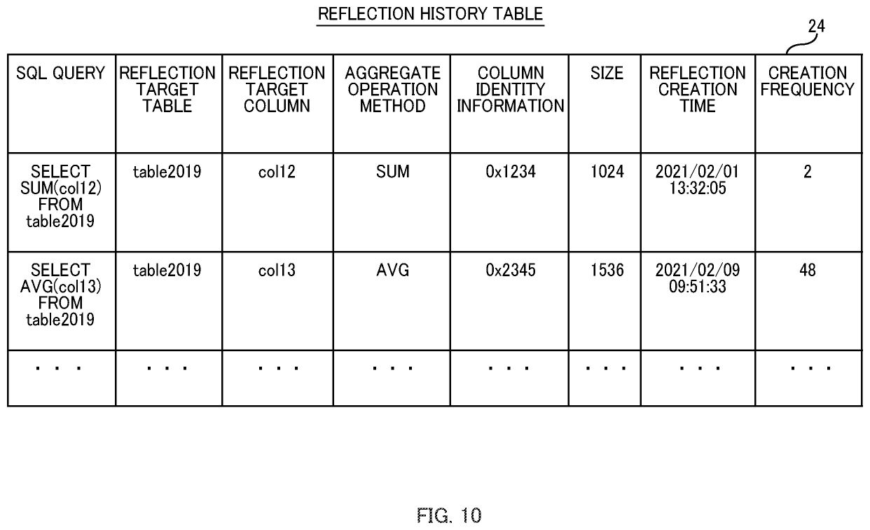

The existing reflection storage capacity is a value obtained by adding up the values in the size column of the reflection history table 24 in FIG. 10 (to be described later). The storage capacity required for the current reflection represents the total size of the columns handled by the reflection to be created.

For all of the maximum reflection storage capacity, the existing reflection storage capacity, and the storage capacity required for the current reflection, the unit of the storage capacity (megabyte or the like) is unified before evaluation of the inequality.

As a result of the determination in step 42B5C described above, when the inequality is satisfied, that is, when the storage capacity is not insufficient (42B5C: No), the reflection creation part 42 moves to step 42B5A. This step 42B5A has already been described with reference to FIG. 7.

On the other hand, when the inequality is not satisfied, that is, when the storage capacity is insufficient (42B5C: Yes) as a result of the determination described above, the reflection creation part 42 moves to step 42B5D.

In step 42B5D, the reflection creation part 42 searches for a reflection that can be deleted. The reflection that can be deleted refers to, for example, the entry whose reflection creation time is relatively older among the entries that satisfy the value in the size column> the storage capacity required for the current reflection in the reflection history table 24 of FIG. 10.

Such a search method is based on an observation that the older the reflection, the more likely it is that the original data set has been updated (that is, the original data set and the reflection are inconsistent).

Alternatively, among the entries that satisfy the value of the size column> the storage capacity required for the current reflection, the entry having a low reflection creation frequency may be specified as the one to be deleted. This is based on an observation that the lower the creation frequency, the less useful it is.

When an entry that satisfies the condition for deletion as described above is found (42B5D: Yes), the reflection creation part 42 moves to step 42B5E. On the other hand, when the entry that satisfies the condition is not found (42B5D: No), the reflection creation part 42 terminates the processing.

In step 42B5E, the reflection creation part 42 deletes the reflection corresponding to the entry found in step 42B5D, and deletes the entry in the reflection history table 24 of FIG. 10.

Here, FIG. 10 shows an example of another embodiment of the reflection history table 24. In the reflection history table 24 in this case, the columns include, from left, an SQL query column, a reflection target table column, a reflection target column, an aggregate operation method column, a column identity information column, a size column, a reflection creation time column, and a creation frequency column.

Among these columns, the SQL query column to the column identity information column are the same as those in the reflection history table 24 shown in FIG. 6. The size column, on the other hand, indicates the storage capacity required for the reflection corresponding to that entry (row). In the reflection history table 24 of FIG. 10, MB (megabyte) is used as the unit as an example, but another unit (for example, GB (gigabyte) or the like) may be used as long as the unit is unified throughout the present disclosure.

The reflection creation time column indicates the time of the creation of the reflection corresponding to the entry (row) that was created. The creation frequency column indicates the creation frequency of the reflection corresponding to the entry (row).

Here, referring back to the description of the flow, the reflection creation part 42 updates the reflection history table 24 of FIG. 10 in step 42B5F, and then terminates the flow.

In this update processing, one row is added to the entries (rows) in the reflection history table 24 of FIG. 10 searched for in step 42B3 of FIG. 5, for example, and the SQL query 22, the reflection target table and reflection target column of the SQL query 22 extracted in step 42B1, the aggregate operation method extracted in step 42B2, the column identity information used for identity determination of the reflection target table and the reflection target column, the reflection size (storage capacity required for the current reflection), and the reflection creation time are written in the added row. Also, the creation frequency is incremented by 1.

The reflection creation part 42 stores in the log file 26 the logs of various processing such as the reflection creation and the update of the reflection history table 24 performed as described above. It is preferable that the reflection creation part 42 outputs such a log file 26 through the input-output device 5 upon request of the user or upon arrival of a predetermined time, for example.

Although the best mode for carrying out the present invention has been specifically described above, the present invention is not limited thereto, and various changes can be made without departing from the gist thereof.

According to the embodiment of the present disclosure, the user of the reflection creation history allows for automatic reflection creation even when not the same but similar queries are used not only for the RDB but also for data such as CSV, JSON, and XML format files. More specifically, reflections can be automatically created for SQL queries by using the reflection creation history.

The description of the present specification clarifies at least the following. Specifically, in the reflection creation system according to the embodiment of the present disclosure, the arithmetic device may be configured to specify queries having the same data extraction target column specified in a new query as queries related to the past reflection of the same content, and to select, from the history, one whose reflection creation source is different from that of the new query among the specified queries.

According to this system, reflections can be created from a table having different attributes such as the time or period and region of acquisition and observation of the target data even though the column, that is, the data to be the reflection creation target and the type of operation are the same. Therefore, it is possible to efficiently create reflections that can be used for temporal changes in data or regional comparison. Thus, automatic reflection creation for SQL queries can be performed more efficiently by using the reflection creation history.

In the reflection creation system according to the embodiment of the present disclosure, the storage device may be configured to further hold information on reflection creation frequency in the history, and the arithmetic device may be configured to execute reflection creation until usage of the reflection storage area reaches a predetermined limit in order from the reflection with the highest creation frequency among those to be created upon creation of the reflections.

According to this system, more useful reflections can be preferentially created in keeping with the availability of the reflection storage area. Thus, automatic reflection creation for SQL queries can be performed more efficiently by using the reflection creation history.

In the reflection creation system according to the embodiment of the present disclosure, the arithmetic device may be configured to execute the reflection creation after deleting the reflection whose creation frequency is less than or equal to a reference value when the usage of the reflection storage area exceeds the predetermined limit upon creation of the reflections.

According to this system, it is possible to create and store useful reflections after securing the reflection storage location, and to expect the operation that allows effective reflections to be continuously maintained, as a whole. Thus, automatic reflection creation for SQL queries can be performed more efficiently by using the reflection creation history.

In the reflection creation method according to the embodiment of the present disclosure, the information processing apparatus may be configured to specify queries having the same data extraction target column specified in a new query as queries related to the past reflection of the same content, and to select, from the history, one whose reflection creation source is different from that of the new query among the specified queries.

In the reflection creation method according to the embodiment of the present disclosure, the information processing apparatus may be configured to further hold information on reflection creation frequency in the history in the storage device, and to execute reflection creation until usage of the reflection storage area reaches a predetermined limit in order from the reflection with the highest creation frequency among those to be created upon creation of the reflections.

In the reflection creation method according to the embodiment of the present disclosure, the information processing apparatus may be configured to execute the reflection creation after deleting the reflection whose creation frequency is less than or equal to a reference value when the usage of the reflection storage area exceeds the predetermined limit upon creation of the reflections.

What is claimed is:

1. A reflection creation system comprising:
a storage device that holds a history of reflections; and
an arithmetic device that selects, from the history, a query whose reflection creation source is different from that of a new query for reflection creation among queries related to a past reflection having a same content as that of a reflection represented by the new query, based on the content of the reflection, and creates a reflection based on the selected query of the past reflection.

2. The reflection creation system according to claim 1, wherein
the arithmetic device specifies queries having the same data extraction target column specified in the new query as queries related to the past reflection of the same content, and selects, from the history, one whose reflection creation source is different from that of the new query among the specified queries.

3. The reflection creation system according to claim 1, wherein
the storage device further holds information on reflection creation frequency in the history, and
the arithmetic device executes reflection creation until usage of a reflection storage area reaches a predetermined limit in order from the reflection with the highest creation frequency among those to be created upon creation of the reflections.

4. The reflection creation system according to claim 3, wherein
the arithmetic device executes reflection creation after deleting the reflection whose creation frequency is equal to or less than a reference value when the usage of the reflection storage area exceeds the predetermined limit upon creation of the reflections.

5. A reflection creation method for an information processing apparatus including a storage device that holds a history of reflections, the information processing apparatus executes processing of:
selecting, from the history, a query whose reflection creation source is different from that of a new query for reflection creation among queries related to a past reflection having a same content as that of a reflection represented by the new query, based on the content of the reflection; and
creating a reflection based on the selected query of the past reflection.

6. The reflection creation method according to claim 5, wherein
the information processing apparatus specifies queries having the same data extraction target column specified in the new query as queries related to the past reflection of the same content, and selects, from the history, one whose reflection creation source is different from that of the new query among the specified queries.

7. The reflection creation method according to claim 5, wherein
the information processing apparatus further holds information on reflection creation frequency in the history in the storage device, and executes reflection creation until usage of the reflection storage area reaches a predetermined limit in order from the reflection with the highest creation frequency among those to be created upon creation of the reflections.

8. The reflection creation method according to claim 7, wherein
the information processing apparatus executes reflection creation after deleting the reflection whose creation frequency is equal to or less than a reference value when the usage of the reflection storage area exceeds the predetermined limit upon creation of the reflections.

9. A reflection creation program implemented by an information processing apparatus including a storage device that holds a history of reflections to execute processing of:
selecting, from the history, a query whose reflection creation source is different from that of a new query for reflection creation among queries related to a past reflection having a same content as that of a reflection represented by the new query, based on the content of the reflection, and
creating a reflection based on the selected query of the past reflection.
